(19) United States
(12) Patent Application Publication
(10) Pub. No.: US 2007/0266862 A1
(43) Pub. Date: Nov. 22, 2007

(54) FILTER WITH SWEETENER

(76) Inventors: Steven Catani, Athens, GA (US); Anne-Lise Lucas, Princeton, NJ (US); Joseph Panarisi, Ocean, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/557,563

(22) Filed: Nov. 8, 2006

Related U.S. Application Data
(62) Division of application No. 10/974,649, filed on Oct. 27, 2004, now abandoned.
(60) Provisional application No. 60/515,093, filed on Oct. 28, 2003.

(51) Int. Cl. A47J 31/44; A47J 31/40; B65B 29/02

(52) U.S. Cl. 99/283; 426/78; 99/284

(57) ABSTRACT

Pervious filters incorporating sweeteners for providing sweetness to liquids passing though the filter and devices incorporating such pervious filters. The filters may be impregnated with sweeteners such as sucrose, sucralose, saccharin, acesulfame-K, stevia, neotame, alitame, asp artame and combinations thereof. The filters may be designed for single use or for multiple uses, and may be used for sweetening any of a variety of beverages, such as, coffee and tea.

### FIELD OF THE INVENTION

The invention relates generally to sweeteners. More specifically, the invention relates to filters incorporating sweeteners for delivering predetermined amounts of the sweeteners to servings of an edible material, such as, a beverage.

### BACKGROUND OF THE INVENTION

Nutritive and nonnutritive sweeteners have long been used to sweeten comestibles, including beverages. High intensity sweeteners have found significant use in consumer-oriented products as essentially zero-calorie replacements for sugar. These sweeteners are useful as aids to diet regulation for such purposes as weight control and for blood sugar control for diabetics. In particular, high intensity sweeteners are commonly used in coffee and tea. Preparation of such beverages traditionally requires that the user have not only a supply of pervious filters and coffee or tea, but also units of sweetener in the form of packets, tablets, or other forms. This requirement sometimes results in the situation where one of the components is out of stock, making the beverage effectively unavailable. The problem may be especially acute in locations such as homes or offices, where small volumes of coffee or tea are consumed and maintenance of inventories of supplies is sometimes problematic. Thus, an object of the present invention is to reduce the number of components needed to produce a sweetened coffee, tea, or other beverage.

### SUMMARY OF THE INVENTION

To achieve this and other objects, and in view of its purposes, the present invention provides, in one embodiment, a device for delivering a predetermined amount of a high intensity sweetener comprising, consisting of and/or consisting essentially of an impregnated filter, the impregnated filter comprising a filter material and a sweetener impregnated thereon.

Another embodiment of the present invention includes a device for delivering a predetermined amount of a sweetener comprising, consisting of and/or consisting essentially of a housing comprising a first cartridge filter comprising a filter element impregnated with a sweetener and a second cartridge filter incorporating a filter element not incorporating sweetener, an inlet at one end of the housing for permitting an incoming liquid to enter the device, a ratioing valve for distributing the incoming liquid to the first cartridge filter and the second cartridge filter, the ratioing in communication with the inlet the first cartridge filter and the second cartridge filter, an outlet at the opposite end of the housing from the inlet for permitting the liquid to exit the housing.

Yet another embodiment of the present invention includes a filter assembly comprising, consisting of and/or consisting essentially of a first filter layer fixed to and opposite a second filter layer, wherein a plurality of sweetener particles are interposed between the first filer layer and the second filter layer.

A further embodiment of the present invention includes a device for delivering a sweetener comprising, consisting of and/or consisting essentially of a first housing comprising an inlet and a first filter not impregnated with a sweetener a second housing opposite the first housing, the second housing comprising a second filter being impregnated with a sweetener and an orifice at its top, an overflow chamber between the first housing and the second housing, wherein the second housing rests on a floor that forms a bottom of the overflow chamber and the orifice is in communication with the overflow chamber such that when liquid in the overflow chamber reaches the orifice it will pass though the second filter, an adjustable bypass valve in communication with the overflow chamber and the second housing, wherein liquid from the overflow chamber can enter the outlet without passing though the second filter, and an outlet positioned to receive liquid passing through the first filter and liquid passing through the second filter and to permit such liquid to exit the device.

Another embodiment of the present invention includes a device for delivering a sweetener comprising, consisting of and/or consisting essentially of a external housing comprising a first filter not impregnated with a sweetener and an internal housing comprising second filter not impregnated with a sweetener, wherein liquid passing through the second filter subsequently passes through the first filter, an inlet, a rationing valve in communication with the inlet, the external housing and the internal housing for directing liquid to the first filter or the internal housing, an outlet positioned to receive liquid passing through the first filter and to permit such liquid to exit the device.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a perspective view of an embodiment of the invention;

FIG. 2A is a side view of an embodiment of the invention;

FIG. 2B is a top view of an embodiment of the invention;

FIG. 3A is a side view of an embodiment of the invention;

FIG. 3B is a perspective view of the embodiment in FIG. 3A;

FIG. 4 is a side view of an embodiment of the invention,

FIG. 5 is a perspective view of an embodiment of the invention;

FIG. 6 is a sectional view of an embodiment of the invention;

FIG. 7 is a sectional view of an embodiment of the invention;

FIG. 8 is a side view of an embodiment of the invention; and

FIG. 9 is a side view of an embodiment of the invention.

### DETAILED DESCRIPTION OF THE INVENTION

As used herein, the terms “Impregnate” and “impregnated” shall mean to coat and coated or to deposit and deposited on or within.

According to the invention, there is provided a device having a pervious filter incorporating a high intensity sweetener. A beverage or other liquid is sweetened by passing it through the pervious filter.

Any sweetener known to one skilled in the art can be used as a sweetener in the present invention. Such sweeteners include, but are not limited to, sucrose, dextrose, fructose, fructans, sugar alcohols, sucralose, saccharin, acesulfame-K, stevia, neotame, alitame, aspartame, other protein sweeteners, and combinations thereof

For simplicity, the following discussion of the devices of the invention, and methods for using them, will recite the choice of sucralose as the sweetener. It is to be understood, however, that the use of any nutritive or nonnutritive sweetener, i.e., high intensity sweetener, incorporated in a pervious filter is contemplated according to the invention. High intensity sweeteners include but are not limited to sucralose, saccharin, acesulfame-K, stevia, neotame, alitame, aspartame, and other protein sweeteners. Combinations of any sweeneter may also be used. It is also to be understood that, although coffee and tea are used as exemplary beverages that may be sweetened by the devices of the invention, the sweetening of any consumable liquid by such filters is contemplated according to the invention.

Pervious filter material suitable for use according to the invention may be of any type known in the food and beverage preparation art, and may be constructed from any of a variety of materials, Typically the material is paper or another fibrous, nonwoven pervious material, but any material known in the art may be used.

The pervious filter made from the pervious filter material may be one designed for a single use, or for multiple uses. Pervious filters according to the invention, like those commonly used in the art, are constructed so as to substantially hold back solids, such as, coffee grounds and ground tea leaves, while liquid passes through the pervious filter material. The pervious filters may contain any effective pore size, provided that the pore size is suitable for effectively filtering a given solid from a given liquid.

In one embodiment of the invention, the device includes a fluted pervious filter, such as is commonly used for coffee-making machines, incorporating a controlled or predetermined amount of a sweetener. Such a filter may have an amount of sweetener sufficient to sweeten one or multiple servings of a beverage as needed, and may be made available in various sweetness levels to accommodate the individual preferences of different users.

In another embodiment of the invention, a bag pervious filter is impregnated with a predetermined amount of a high intensity sweetener. For example, the bag filter may be one such as is commonly used for making tea bags. The bag filter may be of any size, however, and may be impregnated with enough sweetener to treat one beverage serving or multiple servings as needed.

In yet another embodiment, a filter is impregnated with enough sweetener to sweeten many servings of a beverage or other consumable. In this embodiment, the total amount of sweetener delivered to a beverage or other consumable may be adjusted by varying the amount of liquid passing through the filter. Such an approach works especially well when the sweetener is sucralose, whose rapid dissolution and relative insensitivity of aqueous solubility to temperature variations facilitate the formation of essentially saturated solutions of sucralose, with the concentration of sucralose being only slightly affected by the temperature of the liquid. These characteristics facilitate the delivery of predictable amounts of sweetener to the beverage. Conveniently, the filter may be a cartridge filter, but other forms may be used.

Impregnating the pervious filter of the present invention may be done by any method known in the art. For example, an aqueous solution, dispersion or suspension containing a sweetener may be used. The aqueous solution, dispersion or suspension may be sprayed or rolled using a roll coater or gravure cylinder, or by any other mechanism the pervious material onto the pervious filter material at a predetermined load, or the filter material may be dipped or immersed into the aqueous solution, dispersion or suspension of sweetener for a predetermined time. Typically, in the case where a volatile carrier (for example water) is used, the filter or filter material is then dried or cured. The resulting impregnated pervious filter can be used as or incorporated into a sweetening device. Optionally, a vitamin, a mineral, any nutritive material, a flavor, or combinations thereof may be added to the filter by any method known to those skilled in the art.

The filter may have separate treated and untreated sections, such that there is independent flow of two liquid streams through the filter. The relative flow rates may be fixed, or they may be adjustable by valves or other control components known in the art. The two streams are then combined, with the resulting liquid having a sweetness determined, among other factors, by the relative flow rates of the two streams.

In another embodiment of the invention, the sweetener is placed in the form of particles between two layers of filter material, which are sealed together to form a single filter medium. The two layers may be fixed to each other by any methods known in the art, such as fusion bonding, adhesive attachment, or by any other securement means can be used to secure the individual layers together to form the device of present invention. Included within such methods are co-embossing, thermobonding, mechanical bonding and the like. usion bonding includes heat bonding, ultrasonic bonding, and the like.sweetner

If sucralose is used as the sweetener, it may advantageously be provided in the form of crystals having an average size between about 5 μm and about 500 μm. Such a method of incorporating high intensity sweetener into the filter may have particular utility for filters designed to sweeten many servings of beverage, because a relatively large amount of sweetener can be incorporated by sandwiching particles between layers of filter material. Multiple layers of filter medium, with corresponding multiple layers of sweetener between them, may be assembled into large filters, for example in cartridge form.

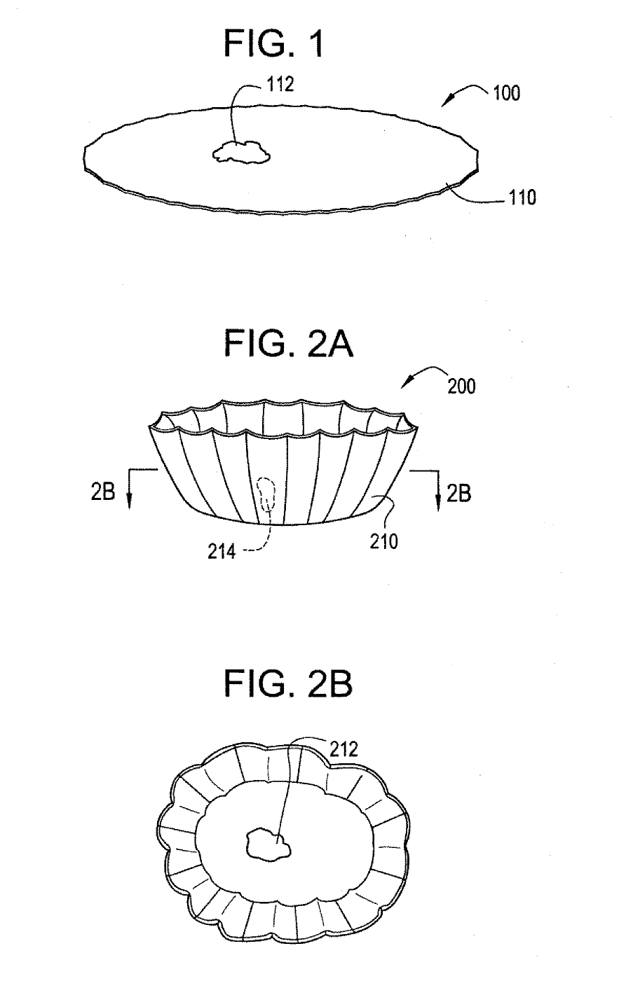

Referring now to the drawing, in which like reference numbers refer to like elements throughout the various figures that comprise the drawing, FIG. 1 shows a substantially flat filter indicated generally at 100, The filter includes a filter material 110 impregnated with a sweetener, indicated at impregnated spot 112. Impregnated spot 112 may extend across the entire surface of the filter material 110, or in one or more selected spots as is shown in FIG. 1.

FIG. 2A shows a fluted filter, indicated generally at 200, according to the invention. The filter 200 includes a filter material 210 impregnated with a sweetener, indicated at 214. In this embodiment, the sweetener is located on a side of the fluted filter 200, rather than on the bottom. Conversely, FIG. 2B depicts a fluted filter 200, shown from the top, in which the sweetener is incorporated on the bottom of the filter at location 212, according to the invention. The sweetener can be located in any location about filter 200, including the entire inside or outside surfaces or parts thereof. Although the filter 200 of FIGS. 2A and 2B may be used for making coffee, it may also be used for any other application requiring the preparation of a sweetened beverage.

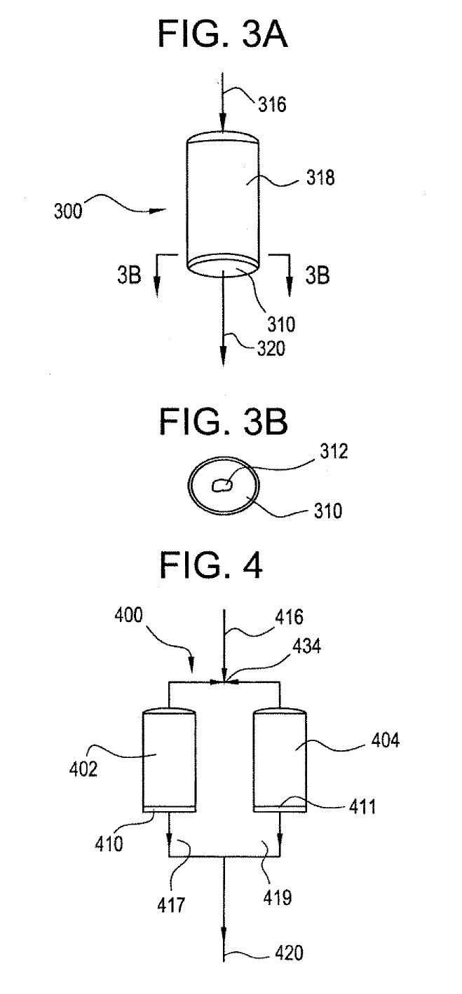

FIG. 3A depicts a cartridge filter, indicated generally at 300, having a filter element 310 impregnated with a high intensity sweetener, according to the invention. The filter element 310 is enclosed in a housing 318, such that water entering the filter 300 via an inlet 316 passes through the filter element 310 and exits at an outlet 320 as sweetened water. FIG. 3B is a detail of the filter element 310. Although the use of water is specifically described, any other consumable liquid may be sweetened in this manner, according to the invention.

FIG. 4 depicts a device according to the invention, indicated generally at 400, including a cartridge filter 402 incorporating a filter element 410 impregnated with a sweetener and a second cartridge filter 404 incorporating a filter element 411 not incorporating sweetener. Water or other liquid enters the device 400 thorough an inlet 416, and is distributed by a ratioing valve 434 to the cartridge filters 402 and 404. Sweetened liquid 417 exits cartridge filter 402 while unsweetened liquid 419 exits cartridge filter 404. Preferably, ratioing valve 434 is adjustable so that the proportion of water or other liquid going to each of the cartridge filters 402 and 404 is adjustable, thereby providing for an adjustable level of sweetness in the liquid (which is a combination of the sweetened liquid 417 and the unsweetened liquid 419) exiting at the outlet 420. In one embodiment of the invention, two or more cartridge filters incorporating sweetener, such as the cartridge filter 402, may be connected to each other in series or in parallel (not shown).

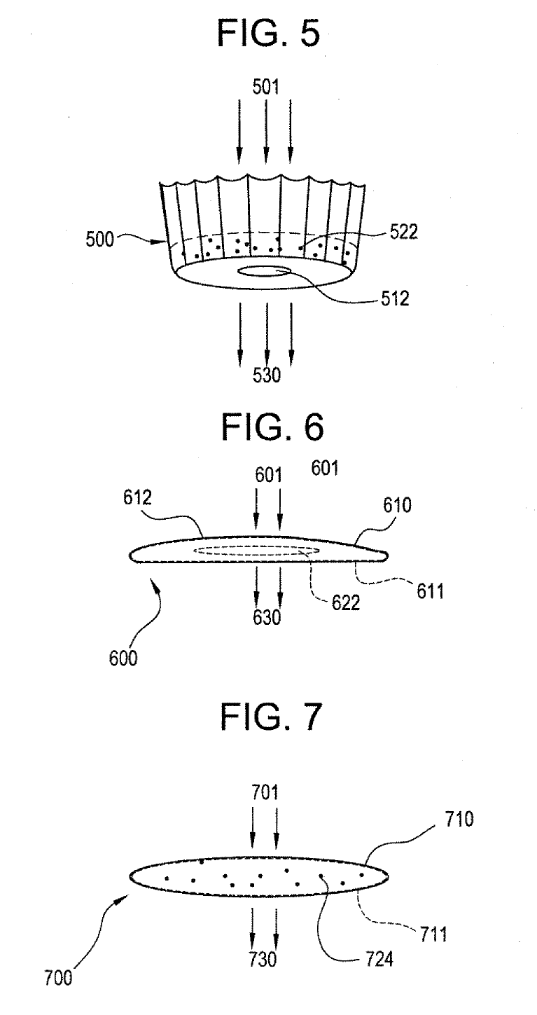

FIG. 5 shows a fluted coffee filter, indicated generally at 500, with a filterable material 522 such as coffee in it, as configured for use according to the invention. Water 501 is introduced into the filter 500, and coffee exiting the filter 500 dissolves sweetener as it passes through a sweetener impregnated spot 512, thereby providing sweetened coffee 530. Although coffee is shown in FIG. 5, it will be understood that other beverages may be prepared in an analogous manner, according to the invention.

FIG. 6 shows a filter assembly according to the invention, indicated generally at 600, having a material 622 such as ground coffee or tea interposed between a sweetener-impregnated filter 610 and a filter 611 that is not impregnated. Sweetener is incorporated at a location 612 on filter 610. Filters 610 and 611 are joined at the edges so as to enclose the ground coffee or tea. As previously noted, the sweetener may cover all or part of the filter 610. The embodiment shown in FIG. 6 may for example take the form of a tea bag, for use as such, or it may be a pre-packaged coffee-and-filter unit whose use requires no measuring out of ground coffee. Other uses will be apparent to the skilled artisan, and are also contemplated within the scope of the invention. The water 601 that enters the filter assembly 600 exits as sweetened material 630.

FIG. 7 shows a filter assembly according to the invention, indicated generally at 700, including particles 724 of sweetener interposed between first filter layer 710 and second filter layer 711, respectively. The first filter layer 710 and second filter layer 711 are affixed to each other at their edges so as to enclose the particles 724. Such affixation may be done by any methods known in the art, such as fusion bonding, adhesive attachment, or by any other securement means can be used to secure the layers together to form the device of present invention. Included within such methods are co-embossing, thermobonding, mechanical bonding, and the like. usion bonding includes heat bonding, ultrasonic bonding, and the like. Water 701 or other liquid is passed through the filter assembly 700, dissolving some of the sweetener particles 724 and thereby producing sweetened water 730 or sweetened liquid.

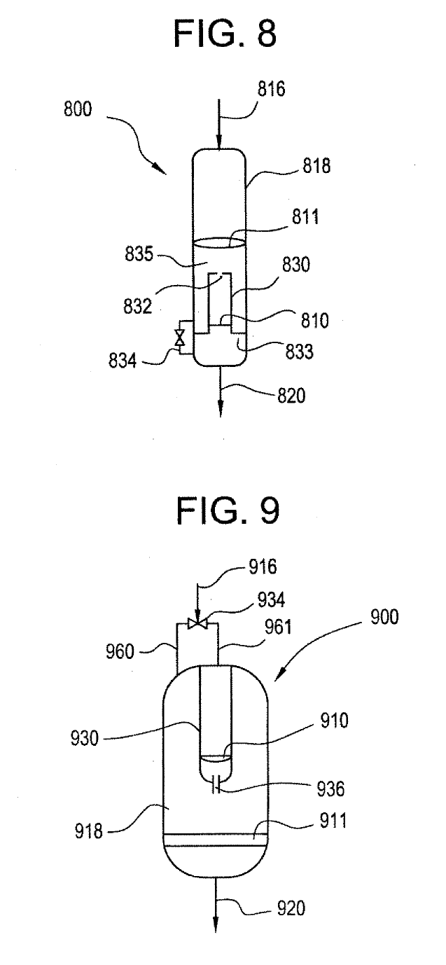

FIG. 8 shows another exemplary device according to the invention, indicated generally at 800, having a sweetener-impregnated filter 810 and a filter 811 not impregnated with sweetener, contained within a single housing 818. The filter 810 is housed in an internal housing 830 having an orifice 832 at its top, and rests on a floor 833 that forms the bottom of an overflow chamber 835. Liquid enters the device 800 at an inlet 816, passes through the filter 811, and fills the overflow chamber 835 to the point where it reaches the top of the internal housing 830, into which it passes through the orifice 832. Liquid passing through the orifice 832 then passes through, and exits, the filter 810 and proceeds to the outlet 820. Before reaching the outlet 820, this sweetened liquid converges with unsweetened liquid passing out of overflow chamber 835 via an adjustable bypass valve 834. By adjusting the flow rate through value 834, the sweetness of the liquid at the outlet 820 can be varied.

FIG. 9 is a side view of another exemplary device according to the invention, indicated generally at 900, having a sweetener-impregnated filter 910 and a filter 911 not impregnated with sweetener contained within a single housing 918. Water or other liquid entering the inlet 916 is distributed by a ratioing valve 934 between direct entry (via route 960) to filter 911 and entry (vial route 961) to internal housing 930, which contains the sweetener impregnated filter 910. Liquid passing through the filter 910 exits the internal housing 930 through an orifice 936, and subsequently passes through the filter 911. The resulting combined flows of sweetened and unsweetened liquid exit the device at an outlet 920. The sweetness of the liquid at the outlet 920 can be varied by varying the distribution of liquid to routes 960 and 961, using ratioing valve 934.

As noted above, one suitable high intensity sweetener for impregnating filters according to the invention is sucralose. Sucralose is highly water-soluble, so that, in the case where all or most of the liquid content of the beverage passes through the filter, essentially all of the sweetener will be released from the filter by dissolution in the beverage. Further, because sucralose is very intensely sweet, only a small amount is needed to sweeten a unit amount of a beverage. In many applications, this facilitates incorporating a desired amount of sucralose into a filter, because only a relatively small amount need be added in order to provide sufficient sweetening capacity. Sucralose is also very stable under typical storage conditions, providing a long shelf life for filters incorporating it.

Devices having sweetener-impregnated filters according to the invention may optionally include other ingredients, including as non-limiting examples flavors and nutrient materials such as vitamins and minerals incorporated into the filters.

Devices according to the invention may find particular advantage in high-volume specialty coffee or tea shops where highly sweetened coffees are made, potentially reducing errors in preparing the beverage by simplifying the process. In this and other applications, the devices of the invention also provide the advantage that accidental release of particles of sweetener dust is minimized, because the sweetener is incorporated into the filter and is not present in an uncontained, free-flowing, powdered form. An added advantage is that packaging waste is minimized, compared for example with the alternative use of sweetener packets.

Although the invention is illustrated and described above with reference to specific embodiments, the invention is not intended to be limited to the details shown. Rather, various modifications may be made in the details within the scope and range of equivalents of the components without departing from the invention.

1-15. (canceled)

16. A filter assembly comprising
a first filter layer fixed to and opposite a second filter layer, wherein a plurality of sweetener particles are interposed between the first filer layer and the second filter layer.

17. The device of claim 16, wherein the sweetener is selected from the group consisting of sucrose, sucralose, saccharin, acesulfame-K, stevia, neotame, alitame, aspartame and combinations thereof.

18. The device of claim 17, wherein the sweetener is sucralose.

19. The device of claim 16, wherein the sweetener is 10 times as sweet as sucrose.

20-27. (canceled)
